(19) United States
(12) Patent Application Publication
(10) Pub. No.: US 2020/0167724 A1
(43) Pub. Date: May 28, 2020

(54) SYSTEMS, APPARATUSES AND METHODS FOR SUPPLY CHAIN NETWORK IDENTIFICATION AND OPTIMIZATION

(71) Applicant: Turvo, Inc., Sunnyvale, CA (US)

(72) Inventors: Konstantin Klitenik, Cambridge, MA (US); John Sweeney, Cambridge, MA (US); Francis Carter Wheatley, Minneapolis, MN (US); Marc Albert Held, Boston, MA (US)

(21) Appl. No.: 16/695,736

(22) Filed: Nov. 26, 2019

Related U.S. Application Data
(60) Provisional application No. 62/772,217, filed on Nov. 28, 2018.

(51) Int. Cl. G06Q 10/08; G06Q 10/06; H04W 4/029; H04W 4/021; H04B 17/318

(52) U.S. Cl. CPC G06Q 10/0833; G06Q 10/06315; H04W 88/12; H04W 4/021; H04B 17/318; H04W 4/029

(57) ABSTRACT

Systems and methods are described for a wireless asset-tracking system that enables automated continuous characterization of aspects of shipment flow through a supply chain. In various embodiments, modular wireless tracking devices traveling with shipments report location and other data to a computational back end. The data are processed by analytic software running on the back end, which produces outputs such as supply-chain maps and metrics. The back-end software monitors for anomalies (e.g., delays, diversions) and notifies the user of prominent issues. In addition, the software remotely manages power consumption by trackers. It may also indicate opportunities for improving the efficiency of the supply chain.

### CROSS-REFERENCE TO RELATED APPLICATIONS

This utility patent application claims priority from U.S. provisional patent application Ser. No. 62/772,217, filed Nov. 28, 2018, titled “SYSTEMS, APPARATUSES AND METHODS FOR SUPPLY CHAIN NETWORK IDENTIFICATION AND OPTIMIZATION” and naming inventors Konstantin Klitenik, John Sweeney, Francis Carter Wheatley, and Marc Albert Held.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2019, Turvo, Inc.

### BACKGROUND

### Field of Technology

This relates to apparatus and methods for tracking the locations of pallets and other mobile assets as they move through shipping systems.

### Background

Managing the material flows of long-distance supply chains is an area of increasing interest to corporations, given global economic integration. In particular, systems for the real-time location tracking of assets such as containers, pallets, packages, vehicles, and the like enable better management. Real-time asset tracking offers numerous opportunities for increasing profitability, e.g., (1) improved estimates of delivery time, (2) more accurate just-in-time inventorying, (3) enabling of corrective action if anomalous asset movements are detected (e.g., delay or diversion), (4) increased shipping velocity enabled by accurate analysis of asset movement patterns, and (4) performance characterization of alternative routes, shippers, packaging technologies, management algorithms, and other aspects of the asset movement system.

Computer applications for asset tracking can be sold as a product or as a service and normally are provided with a standalone application or access to a server that can show the position of a given package or container on a map and, in some cases, calculate various performance metrics. These systems usually support geofencing, route monitoring, and customizable alarms.

In general, asset tracking can be direct (e.g., scanning of barcode tags) or wireless (e.g., radio pinging of tags attached to or integrated with products, vehicles, containers). Wireless asset tracking is likely to dominate the industry going forward because it has the potential to be low labor and high accuracy and does not require that assets be individually accessed by workers or passed through machines so as to enable tag-scanning or other close-range identification procedures. Wireless asset tracking methods depend on telecommunications technologies that allow each asset's location to be determined with sufficient accuracy and frequency (e.g., continuously, periodically, or opportunistically). For example, global navigation satellite system (GNSS) technology and cell-phone signaling have been developed for asset tracking.

However, per-asset cost is relatively high for the existing tracking technologies. For example, GNSS tracking can only justify its cost for relatively valuable assets such as trucks or intermodal shipping containers; the payback from GNSS tracking of a typical shipping pallet, relative to the modest value of the pallet and its contents, is not high enough to justify the added cost. The same is true of other telecommunicative asset-tracking schemes presently on the market. An asset-tracking approach that enables tracking of assets moving through global transport systems in a manner that has low infrastructure requirements and is (a) wireless, (b) automatic, (c) sufficiently resolved in both space and time, and (d) sufficiently low-cost to enable profitable tracking of relatively low-value assets has been shown and described in US Patent Application Publication No. 2018/0139171 (herein the “DNS application”), “SYSTEMS, APPARATUSES AND METHODS FOR TRACKING ASSETS USING DOMAIN NAME SYSTEM [DNS] SIGNALING,” naming inventors Klitenik et al., published May 17, 2018, which is fully incorporated herein by reference.

Moreover, modern operation management seeks to minimize inventory-goods that have been manufactured but not delivered-because keeping inventory on the books costs money (e.g., for storage costs and insurance). For large, complex supply chains, this cost can be on the order of millions of dollars a day. Suppliers therefore wish to keep inventory as low as possible while still meeting demand, and to move inventory through supply chains as quickly as possible. Herein, a “supply chain” is any transport network that moves shippable objects such as pallets or packages.

Goods in transit through supply chains constitute a form of inventory that is herein termed “in-transit inventory.” In-transit inventory creates demand for techniques to cost-effectively increase shipment velocity and reduce accumulation at warehouses and other points in the transport network. Such points of accumulation can typically be assigned to “echelons” (i.e., functionally distinct levels of a supply chain). Other needs of operation management include minimizing overall shipping costs (e.g., through route optimization and choice of shipper) and minimizing losses in transit due to damage, error, and theft.

To realize diverse efficiencies in a complex system requires accurate, continuously updated information about various aspects of the system. Some such information is presently collected for supply chains using a variety of technologies, workers, and communication channels. For example, U.S. Patent App. Pub. No. 2011/0082812A1 (“Package transport monitoring and analysis”, published Apr. 7, 2011, naming inventors Salemizadeh et al.) discloses inclusion within a shipped package of a “test box controller” that can detect a dedicated wireless “package tracking system” at a warehouse or other facility and transmit its ID code and other information through the package tracking system. Another disclosure, International Pub. No. WO2017200398A1 (“ARTICLE TRACKING SYSTEM”, published Nov. 23, 2017, naming inventors VAVIS SUAREZ et al.), describes wireless, battery-powered mobile transponders capable of conserving energy by entering a sleep state. These and other examples of the prior art, including all methods and systems deployed hitherto for collecting shipment-tracking information, e.g., markers or tags scanned wirelessly during passage through special gateways or by handheld optical readers, are readily distinguishable from the present invention. Moreover, typical pallet trackers according to the prior art cost on the order of $100, which is prohibitively expensive for tracking high-volume but relatively low-value shipments. This high cost is entailed by the use in such trackers of hardware for interfacing with the Global Positioning System (GPS) and/or the cellular telephone network; such hardware typically includes a cellular modem, cellular antenna, GPS receiver, GPS antenna, and possibly additional supporting circuitry. By contrast, embodiments of the invention may perform wireless communication using only a WiFi chip and WiFi antenna. These components are relatively inexpensive: e.g., a WiFi antenna may be a microstrip antenna (metal path on a printed circuit board) having negligible cost.

However, most data have hitherto been collected in an unnecessarily expensive manner, or with suboptimal accuracy or frequency, or not at all. There is, therefore, need for an automated, integrated, real-time shipment-tracking system that collects rich shipping metrics (e.g., carrier identity, supplier identity, buyer identity, environmental conditions, high-resolution location and movement) at supply-chain scale and makes these data readily available for inspection and high-level analysis. The goal of such analysis is to inform the management of supply-chain systems, enabling maintenance or increase of shipping speed while decreasing in-transit inventory and direct costs of shipping.

### BRIEF SUMMARY

Herein are disclosed systems and methods for a wireless asset-tracking system that enables automated continuous characterization of aspects of shipment flow through a supply chain. In various embodiments, modular wireless tracking devices traveling with shipments report location and other data to a computational back end. The data are processed by analytic software running on the back end, which produces outputs such as supply-chain maps and metrics. The back-end software monitors for anomalies (e.g., delays, diversions) and notifies the user of prominent issues. In addition, the software remotely manages power consumption by trackers. It may also indicate opportunities for improving the efficiency of the supply chain.

In various embodiments, the invention may comprise (1) hardware units for wirelessly tracking a number of shipments within a supply chain, such tracking units being capable of conserving energy by means of a sleep-wake cycle, (2) a back-end computational software program capable of characterizing aspects of the supply chain based on shipment-tracking and other data and of producing visual displays (e.g., “echelon maps”) and other analytic outputs summarizing aspects of the supply chain, and (3) frequent updating of tracking information and of displays, databases, metrics, mathematical models, and other outputs based thereon. Various embodiments may also comprise (4) an autonomous and/or user-directed back-end software program enabling users to investigate hypothetical changes in the supply chain (via, e.g., modeling and simulation) to identify opportunities for improving transport system performance, lowering cost, and the like. Herein, a “back-end computational software program” is a body of computational code capable of being executed on “back-end hardware,” i.e., computer hardware that is typically housed in a stable location (or set of locations), rather than in mobile devices, and is capable of handling relatively high throughput, e.g., data handling, control, and analytic computations for a large number of trackers. Back-end hardware may be realized in various forms, including but not limited to dedicated mainframe computing systems and distributed (e.g., “cloud”) computing systems.

Advantages conferred by embodiments include cost-effective, automated tracking of specific shipments, detection of delay of particular shipments, detection of inadvertent or deliberate diversion of individual shipments; and the collection, processing, and display of information about shipment flow throughout an entire supply chain in direct support of maintaining or improving the chain's efficiency. Moreover, embodiments may be (a) stand-alone, with no need for costly integration with existing tools (e.g., enterprise resource planning software such as SAP ERP) and (b) carrier-independent, requiring no involvement of cargo carriers such as trucking companies or shipping lines. Various embodiments may also, however, be integrated with existing tools (e.g., enterprise resource planning software such as SAP ERP) and may interface with carrier-specific systems for the collection of data and the performance of other functions.

The prior art does not, unlike various embodiments of the present invention, provide for the opportunistic use of non-dedicated, fortuitously-present wireless devices (e.g., WiFi nodes) both for location identification and for communications (via, e.g., DNS tunneling), as described further below. Nor does the prior art provide for collation of data from a plurality of tracking devices, analytic interpretation of such data by an integral back end, and construction from such data of outputs such as echelon maps and numerical models of the supply chain, enabling a complete virtuous-circle feedback loop for realizing improved efficiency and other advantages. Previously described tags lack most of the functionalities comprised by trackers in the present invention. the trackers comprised by embodiments of the invention, in contrast, are an order of magnitude less expensive. This cost advantage arises in part from the use, in some embodiments, of WiFi for both location and communication, since commercially available WiFi chipsets are a highly mature, mass-produced, low-cost technology.

As shall be further discussed and exemplified herein under the Detailed Description, various embodiments may comprise (1) programmable, re-usable shipment-tracker modules (a.k.a. “trackers”) capable of wireless communications, preferably but not necessarily via WiFi, (2) sleep-wake cycling of trackers to conserve energy and so prolong battery life, (3) collection of data (e.g., service set identifiers [SSIDs] and basic service set identifiers [BSSIDs] of nearby WiFi nodes) by trackers, (4) communication between trackers and a back end (server), including reporting of data by trackers and sending of tracker commands (e.g., sleep-cycle adjustments) by the back end, (5) data analysis by the back end, and (6) presentation to users of back-end analytic outputs, including echelon maps, performance metrics, shipping-anomaly flags, and opportunities for improved shipping efficiency.

Herein, “WiFi” refers to communications methods compliant with the IEEE 802.11 standard, which is known to persons familiar with the art of wireless networking. In various embodiments, wireless communication between trackers and other devices is preferably via WiFi, but there is no restriction to WiFi; alternatives to WiFi include, for example, radio methods compliant with non-WiFi standards such as IEEE 802.15. Also, trackers may be equipped with more than one wireless method (e.g., both IEEE 802.11 and IEEE 802.15). Most broadly, “wireless” communications here include any radio, infrared, visible-light, or acoustic methods, or any combination thereof, capable of enabling low-power communications between trackers and other devices. Moreover, although wireless methods are preferred, direct-contact methods may be employed, additionally or alternatively, in some embodiments: e.g., a tracker may make a direct-contact connection to an on-pallet data bus shared with other devices such as sensors.

Trackers may employ any technically feasible methods, passive and active, for gathering information about tracker location, movement, and environment, including but not limited to detection or exchange of radio signals with WiFi nodes, Bluetooth nodes, the cell phone network, the Global Positioning System (GPS), other trackers or tracking devices, and devices comprising part of the Internet of Things; radio signal strength measurements (which may, in some circumstances, be used to estimate tracker position by triangulation); inertial position tracking; and physical sensor measurements (temperature, light, other). Information gathered by discrete devices may be relayed to trackers (e.g., a GPS receiver on a rooftop may broadcast location information to trackers inside the building via a repeater). WiFi is preferred because of its relatively low cost and other features. Embodiments comprising GPS are also contemplated, but would tend to be more expensive than embodiments comprising WiFi due to the high cost of GPS hardware relative to that of WiFi hardware; also, GPS receivers do not work in roofed spaces such as warehouses, stockrooms, holds of vessels, and the like, which are often served by WiFi. WiFi is therefore, typically though not always, both more flexible and more affordable than alternative or supplementary radio methods.

### BRIEF DESCRIPTION OF THE DRAWINGS

In the drawings, closely related figures and items have the same number but different alphabetic suffixes. Processes, states, statuses, and databases are named for their respective functions.

FIG. 1 schematically depicts portions of an illustrative system for location tracking of assets in a transport system.

FIG. 2 schematically depicts portions of an illustrative tracking device of an asset-tracking system.

FIG. 3 schematically depicts portions of software comprised by illustrative server of an asset-tracking system.

FIG. 4 depicts the movement of a shipment through several echelons of an illustrative supply chain.

FIG. 5 schematically depicts some functional relations between portions of an asset-tracking system.

FIG. 6 depicts steps of a procedure for optimizing a production schedule based on tracking of assets in a supply chain.

FIG. 7 depicts a flowchart optimizing operational flow.

### DETAILED DESCRIPTION, INCLUDING THE PREFERRED EMBODIMENT

In the following detailed description, reference is made to the accompanying drawings which form a part hereof, and in which are shown, by way of illustration, specific embodiments which may be practiced. It is to be understood that other embodiments may be used, and structural changes may be made without departing from the scope of the present disclosure.

In accordance with certain embodiments, systems and methods are disclosed that enable wireless asset tracking in supply chains partly through extant, non-dedicated telecommunications infrastructure; integrated analysis of tracking data by a computational back end; remote management of trackers for energy conservation and other ends; and presentation by the back end of analytic outputs, including echelon maps, to users.

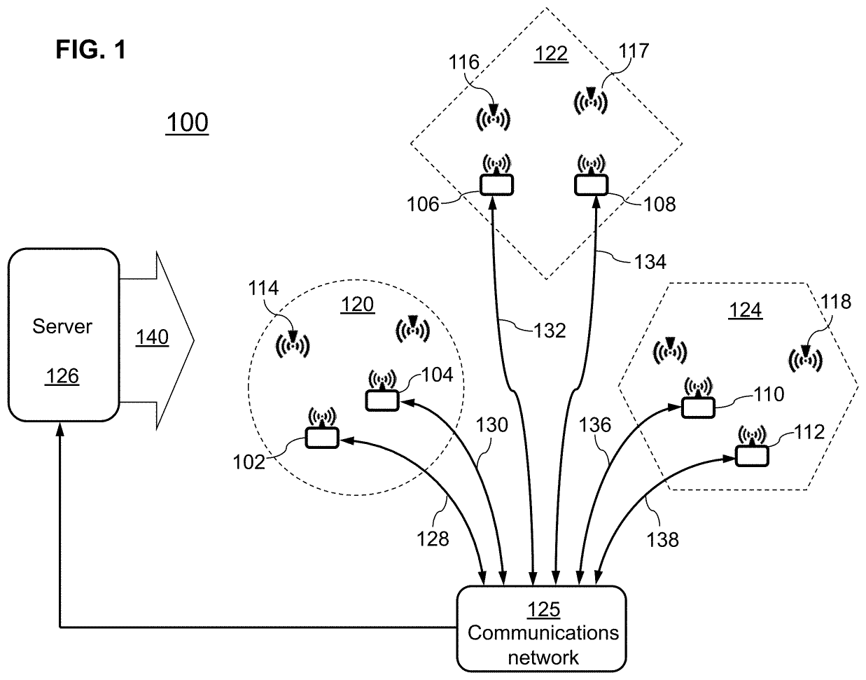

FIG. 1 schematically depicts portions of an illustrative supply-chain network 100 comprising a supply-chain identification and optimization system according to an illustrative embodiment. FIG. 1 depicts a simplistic inventory of components. The functioning of supply-chain identification and optimization systems according to embodiments of the invention will be clarified with reference to both FIG. 1 and subsequent Figures.

In the typical course of operation of various embodiments, shipment tracking devices, herein termed “trackers” and equivalent to the “Modules” of the DNS application, are attached to a number of shipments—one tracker per pallet, crate, package, or other discrete shipment unit—and activated during manufacturing or the shipping process. Thus, the supply-chain identification and optimization system of FIG. 1 comprises a number of trackers 102, 104, 106, 108, 110, 112, each associated with a different pallet (not depicted). The supply chain 100 of FIG. 1 also comprises a number of wireless access points (APs, e.g., APs 114, 116, 118); a first Point of Interest (POI) 120 at a first echelon level (denoted by depicting POI 120 as a circle); a second POI 122 at a second echelon level (denoted by depicting POI 122 as a diamond); a third POI 124 at a third echelon level (denoted by depicting POI 124 as a hexagon); a computational back end or server 126; a number of communication channels 128, 130, 132, 134, 136, 138 by which the trackers 102, 104, 106, 108, 110, 112 communicate with the server 126; and a process of feedback 140 by which the analytic outputs of the server 126 may inform modifications of the supply chain 100. Typically, a supply chain comprises multiple POIs at each echelon level, the number of echelon levels may be any integer larger than zero, and any number of trackers may be present in the supply chain. Also, in a typical supply chain, shipments are moved from one POI to another along routes of transport, e.g., trucking or shipping routes. Routes of transport between the POIs 120, 122, 124, and any shipments or trackers that may be traversing such routes, are not depicted in FIG. 1.

Access Points.

The APs 114, 116, 118 of FIG. 1 are WiFi access transceivers and the communications channels between APs and are constituted by DNS tunneling through the Internet as described in the DNS application.

Trackers.

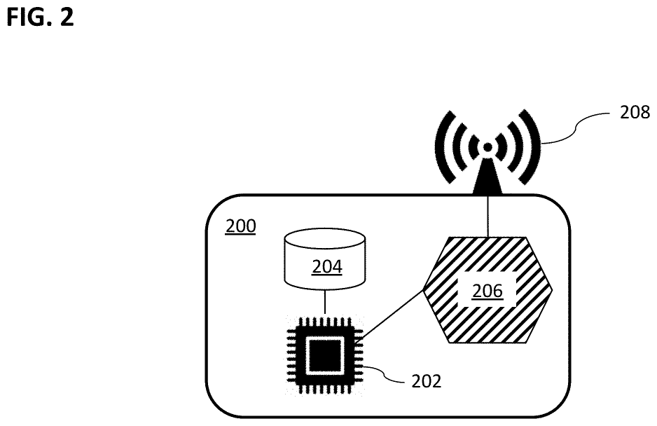

As discussed in more detail with reference to FIG. 2, each tracker is preferably a discrete device comprising a power source (e.g., battery), a microprocessor, and a wireless communication module. In various embodiments, a tracker also comprises sensors, e.g. for vertical orientation, three-axis acceleration, light, magnetic fields, temperature, humidity, or ionizing radiation. Each tracker is programmed with distinctive identification numbers (IDs) and physically attached to or housed within with a mobile asset (not depicted), e.g., pallet, container, or package, for at least the duration of a particular shipping event. Herein, a “shipping event” can be an end-to-end journey of an asset, a portion of such a journey, or a specific action, transfer, or event occurring during such journey, and may include periods both of movement and of residence at one or more POIs. Preferably, trackers are and attached to a large number of the shipments moving through a supply chain, e.g., to most or all of the pallets originating from a particular manufacturer. Tracking a multiplicity of shipments enables advantages, such as supply-chain-wide performance characterization and continuous updating, that cannot be efficiently realized by tracking occasional shipments. Herein, “continuous” (as in, e.g., “continuous updating”) denotes any process that occurs frequently enough to resolve a phenomenon at a useful temporal scale.

In the supply chain 100 of FIG. 1, pallets (and their associated trackers) may accumulate at POIs. The spatial extent of each POI is, effectively, that region within which trackers at the POI can wirelessly exchange digital packet communications with one or more APs. The number of APs at a POI can range from 0 to any higher integer, as can the number of echelons, the number of POIs, and the number of trackers at each POI. In an example, POI 122 may include a regional warehouse and possibly the immediate vicinity of the warehouse, and there are two APs 116, 117 at the POI 122. In FIG. 1, APs at all three POIs 120, 122, 124 are in at least intermittent contact, through a network 125 (e.g., the Internet), with the server 126.

Server.

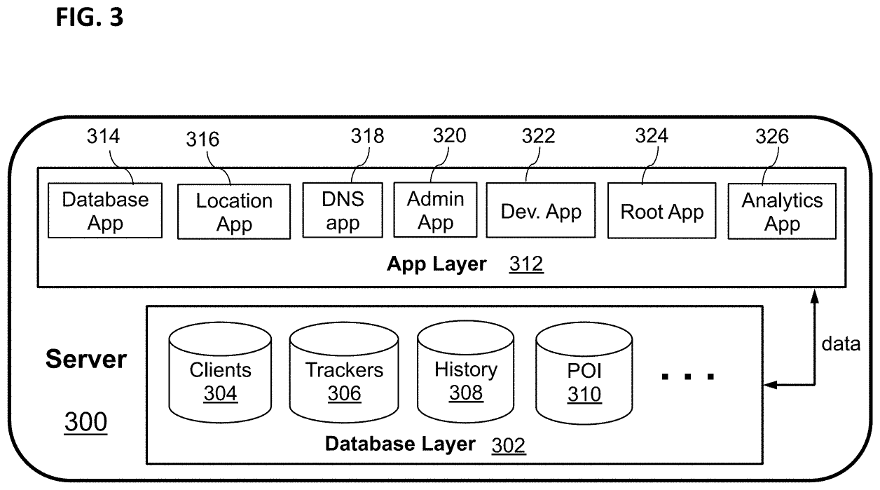

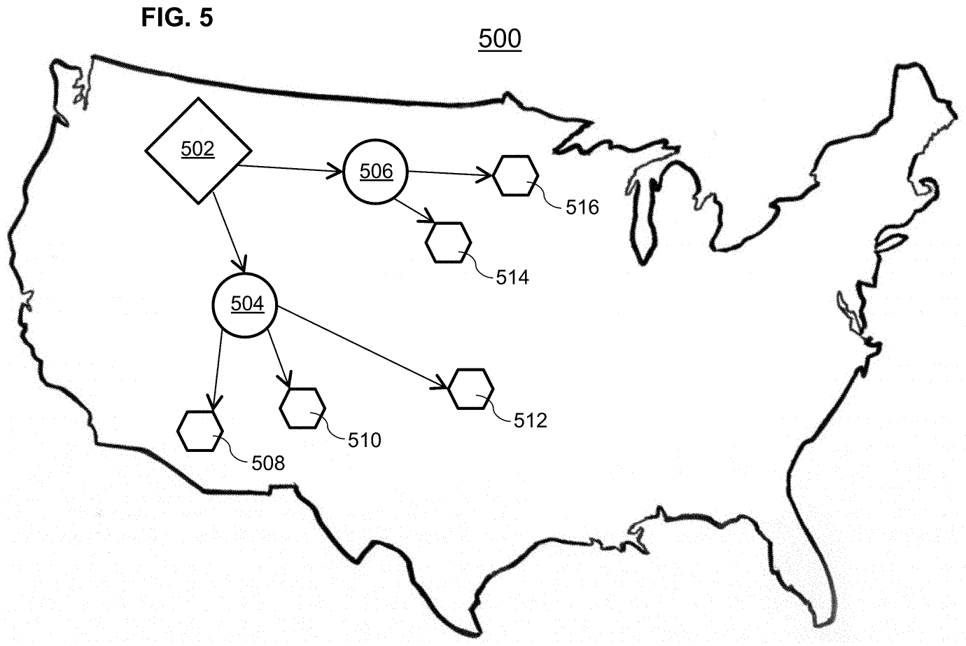

The server 126 of FIG. 1 is a computing device (e.g., laptop, desktop, tablet) capable of storage, retrieval, and generation of data pertaining to the operation of the supply-chain identification and optimization system of FIG. 1. The server 126 includes or encompasses the functions ascribed to a Location Service Server in the DNS application, as discussed further hereinbelow with reference to FIG. 5. The server 126 comprises software programs that implement various functional aspects of the supply-chain identification and optimization system; illustrative server software programs are described below with reference to FIG. 3.

Performance Metrics.

Modifications of the supply chain 100—e.g., changes in shipping schedules, manufacturing schedules, and shipment routing—are informed by analytic outputs of the server 126 in a manner intended to improve selected supply-chain performance metrics. Performance metrics may be selected, in various embodiments, on the basis of one or more of (1) human expert knowledge of the mechanisms and economics of supply chains, (2) supervised and/or unsupervised machine-learning methods, (3) the mathematics of network theory, and (4) other methods. It is preferable that at minimum, performance metrics include shipment losses and errors and first- and second-order statistics on shipment velocity, in-transit inventory, and shipment cost. Measures are preferably calculable, at user discretion, as running averages (e.g., over the last N days), averages over specific time windows (e.g., a past day or month), or averages over specific data subsets (e.g., a specific region, client, shipment type, transport method, sequence of transport links). Metrics may include any quantitative or qualitative summary information pertinent to the supply chain. Specific modifications of the supply chain may be informed by performance metrics on the basis of one or more of (1) expert user judgment, (2) experimental optimization of mathematical models of the supply chain, (3) algorithms (fixed or adaptive), and (4) other methods.

FIG. 2 schematically depicts portions of an illustrative tracker 200 according to an embodiment. The tracker 200 comprises a microprocessor 202, a digital memory (e.g., memory chip) 204, a communications and media interface 206 that handles communications with APs and the back end, and a wireless transceiver 208. The memory 204 typically stores one or more software applications that execute on the microprocessor 202 and that implement functions of the tracker 200; the memory 204 also stores results of scans for APs, parameter configuration settings for the tracker 200, and data from sensors and other sources (not depicted). The microprocessor 202 comprises a timekeeping device and may comprise interface electronics for exchanging commands and data with components not depicted in FIG. 2. The tracker 200 also comprises power storage and conversion components (not depicted) and may comprise sensors and other components. The transceiver 208 is preferably a WiFi transceiver but may be a Bluetooth transceiver or some other type of wireless transceiver; the transceiver 208 may comprise two or more wireless devices of different types (e.g., WiFi and Bluetooth).

Tracker Commissioning.

Typically, to commence tracking of a shipment a user commissions a tracker that will physically accompany the shipment. In an illustrative commissioning process, a user employs a commissioning software program (app) running on a mobile device (e.g., mobile phone). The mobile device preferably communicates with trackers using a wireless modality such as Bluetooth Low Energy (BLE). Using the app, the user creates a record of a new shipment and orders that a particular tracker—which may be physically identifiable to the user by a flashing light and/or beeping noise—be associated with that shipment. The app sends an activation configuration (e.g., clock setting, sleep-wake cycle setting, other settings) to the tracker via BLE and also sends information about the shipment and the tracker's ID and configuration to the back end. In another example, trackers are commissioned by a mobile smart dispenser that charges, assigns, configures, and dispenses trackers for physical attachment to shipments by workers or machines and reports all pertinent information to the back end. In another example, the tracker is automatically activated during manufacture and associated with a specific customer/shipment based on the tracker's movements. Trackers are preferably rechargeable, reusable, and recommissionable.

Tracker Sleep-Wake Cycles.

To prolong battery life, trackers may “sleep” and “wake,” that is, operate in either (1) a low-activity (sleep) state in which power consumption is minimal, little or no computation occurs, and the wireless communication module is minimally active, or (2) an active (waking) state in which power consumption is greater, significant computation can occur, and the wireless communication capability typically receives and transmits significant amounts of data. A sleeping tracker may wake in response to either an external command or a logical condition detected by its own microprocessor, e.g., at a specific time, or upon passage of a programmed time interval, or if acceleration is detected, or if no acceleration is detected for a given time interval.

Typically, a tracker wakes up after a sleep interval of fixed length, performs data collection and communicates as able with the server, and then sleeps again for the same interval. In embodiments, the server can direct trackers to adjust their sleep-interval length based on location to extend tracker battery life. In an illustrative process of sleep-interval adjustment, the server records tracker residence times at each POI (either all measurements to date, or all measurements over some moving window, e.g., previous month) and uses this average as an estimate of expected residence time for trackers arriving at the POI. Historical POI residence times and summary statistics thereof (e.g., averages) may be recorded in the echelon-graph data structure. When a tracker is detected at a given POI, the server orders the tracker to set its sleep period to a large fraction, e.g., ¼ or 1/10, of its estimated residence time there. The sleep period is not, however, set to a time longer than the expected transport time between the current POI and any POI to which the tracker may be shipped from the current POI (where expected transport times are also estimated as averages of past observations), to assure that the tracker will not sleep through transport and then fail for some excessive interval to detect its arrival at a next POI. If there are no historic data on tracker residence times at a POI, tracker sleep period is set to a short default, e.g. 10 minutes. If a tracker wakes and cannot detect any APs, it may be en route in a transport system between POIs, and autonomously sets its sleep period to a short default (e.g., 10 minutes) to assure timely detection of its arrival at a next POI. The duration of a tracker's waking state may be set by the server, or autonomously, or fixedly to a particular value (e.g., 30 seconds), or may be adaptive (e.g., if an awakened tracker does not detect any signals within 10 seconds, it goes back to sleep).

In an example of tracker sleep-wake control according to an embodiment, shipment residence time at a certain POI is known to be on the order of a week; since it is likely that there will be no new information for a tracker newly arrived at that POI to acquire in the coming week, frequent waking would be wasteful of power, so any tracker arrived at that POI is instructed by the server to awaken every 6 hours rather than, say, every 10 minutes. When these trackers are determined or estimated to have left the POI, the server may instruct the trackers to re-adjust their sleep-wake cycle to awaken, e.g., every 2 hours rather than every 6 hours. Nor is the server restricted to past performance in making its estimates of residence and transport times: in an example, the server infers from shipment delays currently reported downstream from a certain POI that pallets will be staying even longer at that POI than normal, and instructs trackers at the POI to wake at an even longer interval than would be normal for that POI (e.g., every 10 hours rather than every 6 hours). It will be readily seen that sleep-wake cycle commands may, in general, be adjusted in response to a wide variety of data types, including transport delays, manufacturing output rates, weather forecasts, expected transport times between POIs, and the like; sleep-wake adjustment by the server based on all these and other types of relevant data is contemplated and within the scope of this disclosure. In various embodiments, trackers can also autonomously change their sleep interval based on other factors, e.g., if a tracker does not detect acceleration for a certain time, it can increase its sleep interval.

Sleep modes for chips can greatly extend battery life; however, microprocessors are typically capable of being set to a number of different sleep states (“C-states”), which conserve different levels of power, so there can be no single figure for how much power is saved by putting a tracker's processor and other electronics to sleep. In an example, in a sleep state, a microprocessor draws ˜0.1% of the power drawn in an awake, working state. At this rate, sleeping the tracker half the time approximately doubles its battery life. In an example, a tracker contains one rechargeable 3.7 V battery that stores ˜2,000 milliampere hours (mAh) of charge. In this example, a tracker uses about 1/1,300 as much power asleep (370 μW) as it does awake (500 mW): thus, to a first approximation, the tracker uses no power while asleep. Under these conditions, programming the tracker to be awake 30 seconds out of every 10 minutes (i.e., 1/20th of the time) extends its battery life by a factor of about 20 (i.e., from ˜24 hours to ˜20 days).

Other Forms of Tracker Control.

Server control and autonomous control of trackers is not limited to setting sleep-wake cycle parameters: particular functions and devices (e.g., sensors) comprised by or controlled by a tracker maybe turned on and off and otherwise modified by commands from the server or by autonomous software of the tracker. In an example of server control according to an embodiment, when a tracker is identified as present at a given POI that is known to the server's POI database, software of the server automatically examines the data for that POI in the database and initiates tracker-control actions conditionally on finding that that POI has certain characteristics. In an example, when a tracker is determined to be at a POI identified in the server's POI database as a temperature-controlled warehouse, the tracker is commanded by the server to turn off temperature sensing, thus conserving energy.

Data Collection by Trackers.

In its waking state, a tracker collects data about its environment. Such data collection may be “opportunistic,” that is, occur only when certain conditions are satisfied: e.g., a tracker has no opportunity to collect information about an AP except when it close enough to the AP to detect the AP's signal. At some times, e.g., during transport by truck, rail, or ship a tracker may have few or no opportunities to sense APs, but at POIs such as warehouses, APs will typically be present. In an example of opportunistic data collection, a tracker detects the service set identifiers (SSIDs; i.e., wireless local area network names) and basic service set identifiers (BSSIDs; i.e., media access control (MAC) address) of WiFi nodes in its vicinity. A preferred minimum for data collection of various embodiments is the collection of SSIDs and BSSIDs for WiFi nodes in the tracker's vicinity. An optional preferred minimum is the wireless collection of device identifiers and signals for components of non-WiFi wireless networks (e.g., cell phone networks, low-power Bluetooth or Zigbee networks). It is preferable that the local device identification be supplemented by the measurement of received signal strength indications (RSSIs) from such devices, because signal strength contains information about distance to transmitter. Since the collection of additional types of data pertinent to location inherently increases the chances of accurately identifying a tracker's location, there is an inherent preference for collecting additional locational information, beyond the minimum; there is thus no restriction on the number of data types or items that a tracker can collect; in various embodiments, the tracker collects SSIDs, BSSIDs, and RSSIs for WiFi nodes, Bluetooth nodes, or other AP types; sensor readings; cell phone network information; global positioning system coordinates; and other data.

Tracker Communication with Server.

In its waking state, a tracker opportunistically communicates with a back-end server. Communication is “opportunistic” if it occurs only when certain conditions are satisfied, e.g., when the tracker is close enough to an AP to exchange signals with the AP and so access the Internet. In an example of opportunistic communication through a WiFi node connected to the Internet, a tracker sends and receives digital packets via DNS tunneling through the WiFi node as described in the DNS application, transmitting by means of such packets its own ID and one or more observed SSIDs and BSSIDs and other observations to the server.

Tracker Communications with Other Trackers.

In various embodiments, a tracker can also communicate opportunistically with other trackers: in an example, a tracker not within range of a WiFi node, but within range of trackers that are within range of a WiFi node, communicates with the WiFi node by means of mesh networking with its fellow trackers, and communicates with the server through the WiFi node and the Internet. Because trackers are typically low-power devices capable only of short-range wireless communication, trackers capable of forming a single local mesh, including those capable only of communicating with other trackers, are highly likely to be located at a single POI, and therefore are assumed to be at a single POI unless information reported by various trackers within the mesh contradicts this assumption. In the latter case, location estimates must be adjusted in a case-by-case manner that depends on the nature of the contradiction: in an example, a single tracker works with a number of other trackers that agree on a certain POI, but reports an SSID and BSSID associated with a far-distant POI. The back end analytic capability (discussed further below) provisionally overrules the dissident tracker and maps it to the POI identified from the majority of meshed trackers. In an illustrative tracker networking topology, the minimum number of trackers that a mesh can contain is 2 and the maximum number is bounded by hardware specifics such as tracker memory size. This and many other viable forms of tracker networking will be familiar to persons skilled in the art of communications engineering.

The tracker subsystems and methods just described are illustrative, not restrictive: various embodiments comprise subsystems that depart from this description, while ultimately providing equivalent services.

FIG. 3 schematically depicts portions of an illustrative server 300 comprised by an illustrative supply-chain identification and optimization system according to an embodiment. The server 300 is a computing device (e.g., laptop, desktop, tablet) capable of storage, retrieval, and processing of data. In various embodiments, the server 300 is not a unitary computing device (e.g., desktop computer); that is, its computational and data-storage capabilities may be realized by multiple devices, either redundantly or in a distributed (e.g., cloud-computing) manner. Thus, no restriction is intended by the representation of the server 300 as a unitary device in FIG. 3.

Software running on the illustrative server 300 is organized into a number of layers, e.g., a Database layer 302 and an Apps layer 312. The Database layer 302 implements access to one or more databases, e.g., a Clients database 304 recording asset identification and other information pertaining to particular asset owners, a Trackers database 306 recording configuration and other information pertaining to individual trackers, a History database 308 recording information pertaining to past operations of the supply-chain identification and optimization system, a POI Database 310 recording locational and other information pertinent to POIs in a supply chain, and potentially other databases, indicated in FIG. 3 by ellipses, that may contain data pertinent to the conduct of the supply-chain identification and optimization system (e.g., measured characteristics of various routes, carriers, management strategies, and the like). Information in databases may be derived from publicly available data, data supplied by customers and other third parties, sensor and other data reported to the server by trackers and other devices located throughout the supply chain, and other sources.

The server 300 also comprises software programs (also referred to herein as “apps”) that implement various functional aspects of the system. The apps are typically managed by the Apps layer 312. Apps can include a Database app 314 that maintains the contents of the Database layer 302 and retrieves information for serving to trackers and elsewhere as needed; a Location app 316 that algorithmically estimates tracker locations based on various data types (e.g., the Location app performs geo-lookup by matching tracker-reported BSSID data with BSSIDs in a database containing longitude-latitude information for BSSIDs, such as maintained on the server or through third party services such as Google Location services or wigle.net); a DNS Client app 318 that handles DNS tunnel encapsulation and decapsulation and other DNS-specific tasks; an Administrative app 320 that enables a master user to act at an operations management level; a Developer app 322 that enables access to the application programming interfaces of the system for application development; and a Root app 324 that enables master control over other user categories and access to everything contained in the Database layer 302; and an Analytics app 326 capable of calculating performance metrics, modeling the performance of real or hypothetical supply chains, and performing other calculations pertinent to management of the supply chain. In various embodiments, the functions realized by the database layer 302 and the apps 314, 316, 318, 320, 322, 324, 326 as well as by other apps that may be comprised by the server 300 but are not depicted in FIG. 3, are realized by a differently organized set of applications or software modules. Moreover, apps comprised by the Apps layer 312 and databases comprised by the Database layer 302, and/or other software and databases comprised by the server 300, are not necessarily stored in a single memory device, but may be stored in a distributed and/or redundant manner over a number of hardware devices. The server subsystems just described are illustrative, not restrictive: various embodiments comprise subsystems that depart from this description, while ultimately providing equivalent services.

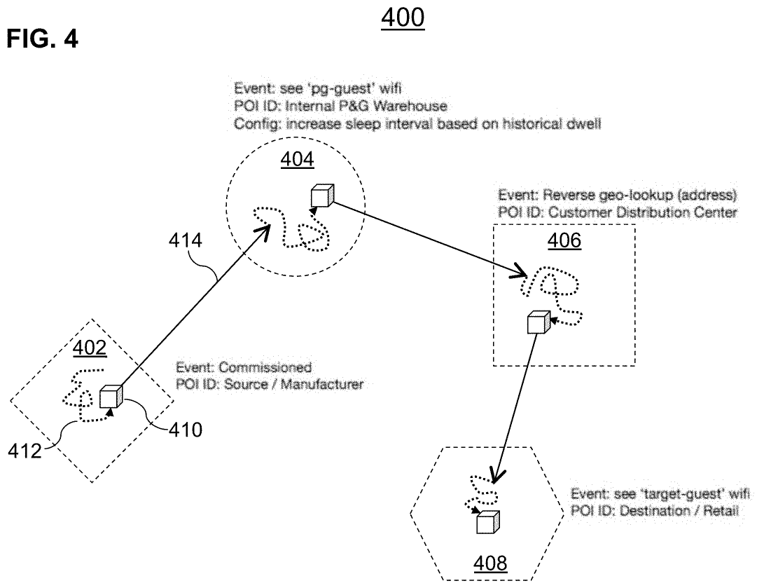

FIG. 4 schematically depicts an illustrative supply chain 400 comprising four POIs 402, 404, 406, and 408 and the passage of a single pallet 410 through the supply chain 400. The pallet 410 is equipped with a tracker (not depicted) that is part of a supply-chain identification and optimization system (not explicitly depicted) according to an illustrative embodiment. The shipment event that transfers pallet to POI 408 begins at POI 402, an Echelon 1 POI (diamond-shaped symbol). Small local movements 412 (chaotic dotted line) of the pallet 410 are detected by the supply-chain identification and optimization system of the tracker, e.g., by triangulation among wireless access points (not depicted) at POI 402 based on signal-strength measurements made by trackers and transmitted to the server: however, the supply-chain identification and optimization system is intelligent enough to ignore such minor movements and conclude that pallet 410 remains at POI 402. Such intelligence may comprise, in an example, the ability to note that movements remain below a specific distance threshold D (e.g., 100 meters), and that this condition persists for at least a specific time threshold T (e.g., 1 hr), and to conclude that the pallet 410 is residing at POI 402. Echelon 1 may be a manufacturer's warehouse. As indicate by text positioned by the symbol for POI 402, while pallet 410 is at POI 402 the server of the supply-chain identification and optimization system records the event of commissioning the tracker for pallet 410 and notes that the POI 402 is a specific source/manufacturer. The identity of POI 402 may be known a priori, or determined (or double-checked) by examining SSIDs detected by the tracker for pallet 410 while at POI 402.

After residing for some period at POI 402, the pallet 410 is moved by a shipping route 414 to POI 404, an Echelon 2 POI (circular symbol). Echelon 2 may be a long-haul shipper's warehouse. The pallet 410 resides for some time at POI 404, perhaps making detectable local movements. While the pallet 410 is at POI 404, the tracker reports seeing SSID distributor_name-guest, the server identifies the POI accordingly as a warehouse of the distributor “distributor_name,” and the server commands the tracker to increase its sleep interval based on historically observed long dwell times at this POI.

The pallet 410 is then moved to POI 406, an Echelon 3 POI (square symbol). While the pallet 410 is at POI 406, the server determines the echelon of POI 406 by reverse geo-lookup (based on BSSID lookup for physical location); the POI is identified as a specific customer distribution center. Finally, the pallet is moved to POI 408, an Echelon 4 POI (hexagonal symbol). Echelon 4 is a retail store. While the pallet 410 is at POI 404, the tracker reports seeing SSID retailer_name-guest and the server identifies the POI accordingly as a store location for the retailer “retailer_name.”

Preferably, numerous other shipments are tracked simultaneously throughout the supply chain 400. Analysis by the server of the supply-chain identification and optimization system will derive residence times for the pallet 410 and other shipments at the POIs, transit times between POIs, and possibly other metrics pertaining to the supply chain 400. In general, the number of POIs at each echelon may vary: e.g., for each regional distribution center POI 406, there are likely to be a number of retail stores (e.g., POI 408) to which shipments may be directed.

FIG. 5 is a simple, illustrative echelon map 500 showing the approximate physical locations of one Echelon-1 POI 502, two Echelon-2 POIs 504, 506, and five Echelon-3 POIs 508, 510, 512, 514, 516. Various embodiments can produce echelon maps enriched by any data available to the server and employing any methods of graphic representation. In the example of FIG. 5, POIs are connected by one-way arrows signifying transport links from higher echelons to lower echelons; however, in various embodiments, individual transport links may be two-way, and/or may be one-way ascending from a lower echelon to a higher echelon, and/or may connect POIs of a given echelon level to each other in a one-way or a two-way manner. Moreover, transport links may skip echelon levels (e.g., connect a Echelon-1 POI directly to an Echelon-3 POI), and multiple transport links may connect to any given POI at any echelon level. A major purpose of the echelon map is to represent salient features of a real or simulated supply chain: the echelon-map concept therefore includes sufficient flexibility to represent all varieties of supply-chain connectivity that may really occur or be of at least speculative interest.

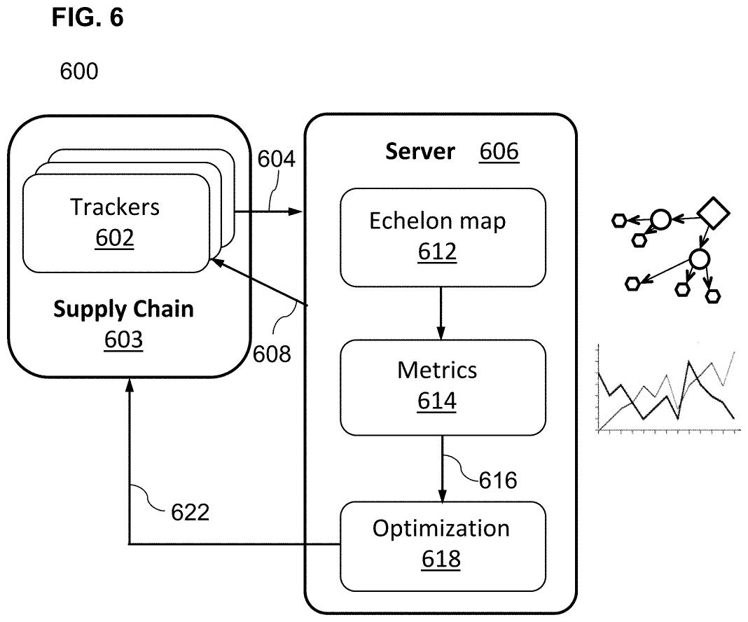

FIG. 6 schematically depicts some components, relationships between components, and information flows between components comprised by an illustrative supply-chain identification and optimization system 600 according to an illustrative embodiment. As detailed below, system 600 comprises the following components and methods: (1) a plurality of shipment-tracker modules (a.k.a. “trackers”), each tracker physically associated with a particular pallet, package, or other shipment unit, (2) tracker sleep-wake cycling, (3) data collection by trackers, (4) communication between trackers and a back end, (5) data analysis by the back end, (6) presentation of back-end analytic outputs to users.

System 600 comprises a plurality of trackers 602 embedded within a supply chain 603. SSIDs, BSSIDs, and other data 604 collected by trackers are transmitted (e.g., by DNS tunneling as described in the DNS application) to a computational back end or server 606. The software of the server 606 analyzes the data 604 from the tracker set 602. As a result of analysis, the server 606 may send actionable instructions 608 to selected trackers, e.g., commands to shorten or length tracker sleep periods or power up or power down sensors. Other analysis outputs of the server 606 include data structures, model parameters, and the like; a typical data structure produced by the server 606 is a frequently-updated echelon map 612. As noted hereinabove, the echelon map concept includes both an underlying data structure and any visual representations (tables, maps, texts, etc.) derived therefrom. Various metrics 614 can be derived by the system 600 from the echelon map 612 and potentially other data. Selected metrics 616 are used as inputs to an optimization or improvement procedure 618. In an example, the optimization procedure 618 comprises a numerical model of a supply chain 603 monitored by system 600, and varies select parameters of said model using Monte Carlo methods to see if altered parameter values can improve selected metrics, e.g. cost per shipment or mean shipment speed. If the optimization procedure 618 indicates that one or more aspects of the supply chain 603 can be improved, a management process 622 informed by outputs of the optimization procedure is undertaken to alter the supply chain 603 accordingly. Subsequently, the effects of alterations in the supply chain 603 are discerned by the analytic software of the server 606 based on data from trackers 602; this information can be used to compare predicted change to actual change and to confirm or refine the model employed by the optimization procedure 618.

Analysis: Tracker Location.

In the illustrative embodiment FIG. 6 and various other embodiments, the server collects and interprets (analyzes) raw data from one or more (preferably, many) trackers. In an example, the Location app of the server estimates the current physical locations of a number of trackers by looking up SSIDs of WiFi nodes reported by the trackers. An SSID can reveal information such as the corporate owner of a given WiFi node (e.g., an SSID reading “company_A-guest” typically indicates a WiFi node serving “Company A”), which may indicate, in a particular supply-chain context, that the tracker is in a certain warehouse belonging to Company A. Both the location of the facility and the echelon to which it belongs can typically be inferred from an SSID detected at the facility and from other data (e.g., previous facilities detected).

Analysis: Points of Interest.

Herein, a facility, location, or point that at least occasionally contains a certain threshold number P of trackers is termed a point of interest (POI), where “facility,” “location,” or “point” is a finite, preferably stationary volume such as the interior of a warehouse, big-box store, or fenced enclosure. A typical POI is a warehouse or other point in the supply chain where shipments temporarily accumulate en route to their destinations. POIs are of particular interest because they likely contain a large portion of the chain's in-transit inventory, which a user wishes to minimize. The physical location of a POI may be known, unknown, or inferred with some probability. Preferably, each POI is associated by the server with both a physical location and an echelon. Four POI echelons in an illustrative supply chain are (a) manufacturer's central warehouse, (b) regional distribution centers, (c) local warehouses, and (d) retail locations. Preferably, the Analysis app of the server detects if a tracker has entered or exited a previously known POI.

The POI tracker-accumulation threshold P is greater than 1 and may be usefully defined by various means, depending on the nature of the supply chain: preferably, P is large enough (e.g., 20 or 100) to exclude small, random collocations of pallets at locations (e.g., loading docks, individual trucks) that do not correspond to distinct echelons of the transport system. P is an analytic parameter, not an objective mechanical feature of the supply chain, and so may be defined in a fixed, time-dependent, analytic-task-specific, client-specific, supply-chain-specific, or data-dependent manner. Nor is there any restriction to a single threshold P for the identification of significant tracker/pallet groupings: thus, for example, Q classes of pallet grouping size may be defined by Q grouping size ranges [Pᵢ], in which case, for j pallets, the lower bound Pᵢ₋₁ and upper bound Pᵢ of each grouping range [Pᵢ] are given by Pᵢ₋₁<j≤Pᵢ, where 1≤i≤Q, P₀=1, and P_{Q}=∞ (no bound on largest size class). E.g., a network manager may be interested in tracking Small POIs (1<j≤10), Medium POIs (10<j≤100), and Large POIs (100<j). Other schemes of classifying pallet groupings by size are readily envisioned, whose usefulness will depend on the particulars of actual supply chains and managerial needs; all such schemes are contemplated and within the scope of this disclosure. Moreover, in various embodiments the definition of a POI does not depend only, always, or at all upon the number of pallets that at least occasionally accumulate therein, but upon other criteria, e.g., average length of residence of pallets at the location.

Insertion of a location as a POI in a data structure (e.g., echelon map) may be performed by software in an unsupervised manner when certain criteria are met, such as detection of P or more pallets at the location, or may be performed manually (e.g., based on a description of supply-chain facilities such as warehouses), or may be performed by software in a manually supervised manner. In an illustrative case, an accumulation of 32 trackers at a hitherto unlisted location exceeds a threshold P=20 and is flagged as a likely POI by the Analytic app of the server, which seeks to autonomously determine additional information about the possible POI by geolocating WiFi BSSIDs reported by trackers at the location. The Analytic app of the server also flags this likely-POI observation for human operator attention (e.g., posts an alert to the graphic user interface). In response, the operator examines the SSID and geolocation information collected by the server, determines that the candidate POI appears to a FedEx facility not hitherto listed as a POI, contacts FedEx, verifies that a new FedEx warehouse has been added to the supply chain, and populates the server's POI database with the new POI's geolocation, corporate owner, detected SSIDs and BSSIDs, and other pertinent information as available. The echelon map is thus kept up-to-date.

Analysis: Data Structures.

As the foregoing example illustrates, the Analysis app of the server constructs or updates one or more data structures based on raw data and/or interpreted data from trackers and possibly other sources. These data structures vary in complexity from lists associating tracker IDs with detected SSIDs and BSSIDs to dynamic computational models of entire supply chains. Supply-chain models may correspond to actual or simulated supply chains and may incorporate real-world or fictional data: in an example, a model of an actual supply chain comprises real data about pallets (e.g., type, number, weight, value, owner, source, destination, estimated location, environmental measurements reported by trackers), POI listings, in-transit inventory at POIs and/or aboard transport systems, data on ships and planes (e.g., departure/arrival/present location, shipping manifests), and other information about the present state of the supply chain, and these data, combined with similar information about past states of the supply chain, are used as inputs into mathematical equations comprised by the Analytic app of the server that forecast future states of the supply chain.

Analysis: Echelon Maps.

Another example of a data structure created by a server is an echelon map (or “echelon graph”) that assigns trackers to echelon-specific POIs at known locations. An exemplary echelon map has been depicted in FIG. 5.

In an illustrative echelon-map data structure according to an embodiment, the echelon map for a particular supply chain is encoded as a graph in a graph database system. The graph comprises nodes and edges (a.k.a. “relationships”). Each node has a label, denoting the type of object it represents, as well as other data specific to the node. The edges encode relationships between the node objects and can also be given labels. For a given supply chain, there are two types of graph nodes in the echelon map structure, (1) nodes that represent echelons (“echelon nodes”) and (2) nodes that represent POIs (“POI nodes”). An echelon node represents a type of facility in a supply chain; for example, there must exist at least one echelon that has the facilities for commissioning tracking devices. In the graph structure, echelon nodes are given a label (e.g., “Origin,” “Distribution Center,” or “Retail”), and edges between echelon nodes are added to encode movements between types of facilities in the supply chain. For example, an edge between the Origin node and a Distribution Center node indicates that after having been commissioned at the Origin node, a tracking device should move to a distribution center facility. Multiple edges may originate from a single echelon node. A POI node represents a POI. Information encoded in a POI node may include the location of the POI, a unique POI identifier, and statistics on the history of tracker activity associated with the POI. If a POI is on an edge from an echelon node, then that POI is a member of that echelon.

To encode the observed movements of trackers through the illustrative echelon graph, the graph also comprises Shipment nodes and Lane Traversal nodes. A Shipment node stores the unique identifying information of each shipment, information on when the shipment originated, and the ID of the tracker used for the shipment. A Lane Traversal node stores the movement of a given tracker between two POIs. The edges from a Lane Traversal node encode the time of departure and arrival to the POIs of departure and arrival respectively. An edge from the Shipment node to the Lane Traversal node represents the first leg of the shipment's journey, and edges between Lane Traversal nodes encode the sequence of lane traversals for the shipment. By traversing the graph's Lane Traversals, one can determine shipment dwell and transit times at and between POIs. Statistics about echelons and POIs may be computed by aggregating the dwell and transit times for a set of shipments.

The data structure of an echelon map may serve as the basis for a variety of visual representations. In a preferred example, a visual representation superimposes a number of POI symbols upon a geographic map, using distinctive shapes and/or colors to assign each POI to an echelon, labeling each POI with the number of shipments located therein, and using arrows to denote transport links joining POIs. In an illustrative process of constructing an echelon map de novo, a number of POIs are identified and assigned into unnamed echelons based on historical shipment movements. Some POIs and echelons can be identified and labeled automatically using (a) reverse geo-location lookup to determine what sort of facility is at the address, and/or (b) lookup of WiFi SSID(s) detected at the POI(s) (e.g., SSID=company_a-guest may indicate an internal “Company A” warehouse, while SSID=target-guest may indicate an end retail location at a Target store). Here, “lookup” may entail direct tabular lookup of a list of SSID location and/or more complex approaches to estimating location that combine SSID data with other spatial, temporal, or environmental data. In an example of inference from combined data types, a given time lapse between tracker check-in from two POIs may show that the second POI must be within a certain distance of the first POI, which may in turn identify the second POI unambiguously or at least decrease the number of possible POI locations. In another example of inference from combined data types, detection by a tracker of an SSID=herestobeer, combined with data (from, e.g., a shipper) showing that the tracker is somewhere in St. Louis, Mo., might enable an artificial intelligence to infer that the POI is likely a certain Anheuser-Busch warehouse.

Ambiguity in the status of a given POI may be brought to a user's attention for manual clarification, which can then incorporated into the forming echelon map. An echelon map can be a time snapshot, continuously updated, animated in accelerated time to depict history, or otherwise constructed using various graphic-display techniques. An echelon map may display data produced entirely by a mathematical model of the transport system (e.g., a simulation). There is no restriction on the number of data types that might be displayed on an echelon map in various embodiments, or on the methods by which such data are displayed. Once constructed, the echelon map shows how various POIs in the supply chain are interconnected and how the product flows through the supply chain. Herein, the term “echelon map” refers not only to a visual display of echelons, but to the data structure(s) underlying any such displays. In embodiments, the underlying data structure supports analytics such as (a) performance by echelon level (transit time, dwell time, etc.), (b) lead time from echelon level to echelon level, (c) inventory build up at each echelon level, (d) anomaly detection (delays, shipment off-course, etc.), and (d) mathematical modeling of the supply chain, including both real-world modeling and simulation. Mathematical modeling by the server can inform decisions that improve movement of goods through the supply chain and/or minimize inventory build up. For example, analytics may suggest a more optimal route from point A to point B or advise increased/decreased production based on inventory buildup in the supply chain.

In various embodiments, the “echelon” concept is not limited to a hierarchy of stationary POIs such as warehouses but includes other portions of transport systems (e.g., ships, trucks). As the Internet of Things develops, trackers will increasingly encounter wireless devices associated not only with stationary POIs but with vehicles, smart machines, indoor location services, and the like. One- or two-way communication between trackers and any or all wireless devices, and the use of data collected by trackers and any devices with which they communicate, this data being communicated to the back end to characterize a supply chain in terms of flexible echelon/POI concepts, is contemplated and within the scope of this disclosure.

Analysis: Optimization of Supply Chain Operations.

In an illustrative method of improving movement of goods through a supply chain by analyzing the data structure of an echelon map organized as a graph of nodes and edges according to an embodiment, an echelon graph encodes information about each transit of a tracking device between two POIs: e.g., departure and arrival times, sensor data such as temperature readings, and a summary of the route taken. If a user (customer) indicates that they wish a shipment to transit between two POIs, POI A and POI B, the history of traversals that also transited between POIs A and B can be extracted from the graph and statistics aggregated by route can be computed and presented to the user. For example, a moving average of transit times between POIs A and B using each distinct route can be computed and presented as the expected transit time for each route. The moving average of average temperature by route can be computed and presented to the user. The user can then examine these statistics by route and determine the route between POIs A and B that best matches their selection criteria (e.g., speed, cost, exposure of shipment to environmental stresses). Such examination may be done according to the judgment of a human operator or by a mathematical optimization process; a number of such mathematical processes are known to persons familiar with the art of system theory.

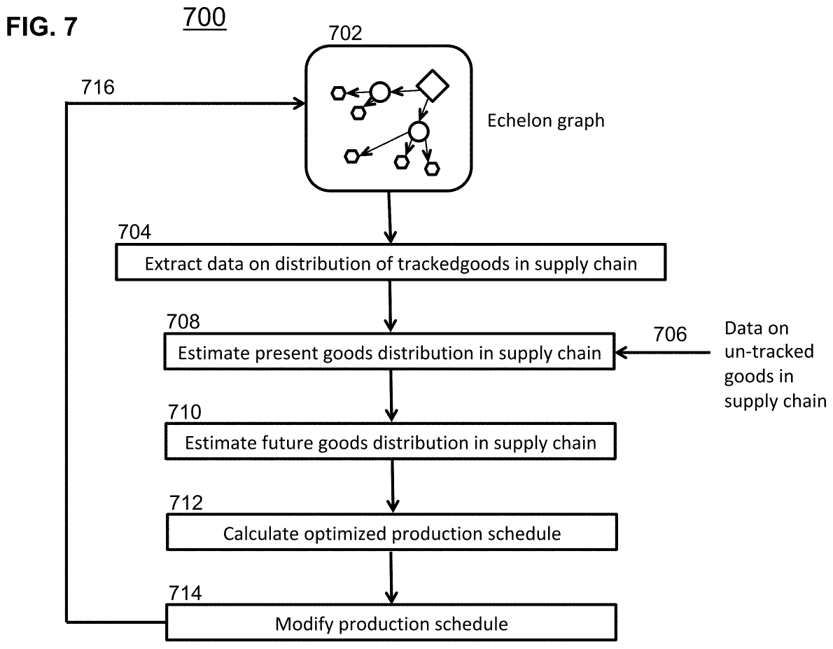

FIG. 7 depicts portions of the operational flow of another illustrative method 700 of optimizing supply-chain operations according to an embodiment, at any moment, software can be made to traverse an echelon graph 702 to count the number of trackers active at each echelon in a supply chain. Data on distribution of tracked goods (i.e., shipments bearing trackers) are extracted 704 from the echelon graph 702. If data 706 are available (e.g., from the shipment originator) on how many goods are in the supply chain without tracking devices, then the ratio of goods with tracking devices to goods without tracking devices is known, and net inventory levels of goods at each echelon in the supply chain can be estimated 708 by adding tracked and untracked goods. The time series of this net inventory level may be used as an input to a mathematical estimation process to estimate 710 current and future inventory levels at a given echelon node or throughout the supply chain; a number of such mathematical processes are known to persons familiar with the art of system theory. These estimates can in turn be used as inputs to a model of a manufacturing process, along with other inputs such as cost and demand, to estimate 712 an appropriate level of production at any given time. Production output of a manufacturing process can be modulated 714 accordingly, which modifies the behavior of the supply chain. Modified supply-chain behavior constitutes a feedback 716 that is ultimately reflected in the contents of the echelon graph 702. Additional mathematical processes (not depicted) may be used to compare the expected effect of production output modulation on supply-chain behavior and to refine methods of estimation, prediction, and control.

Analysis: Sensor Data.

Additionally, data from environmental sensors reported through trackers may be incorporated into various aspects of the server's analytic activity. In a series of examples, environmental sensors may (1) provide cues to shipment location (e.g., the measured strength and inclination of Earth's magnetic field can be contribute to the disambiguation of a location estimate), (2) enable monitoring of storage conditions (e.g., humidity, temperature) to detect potentially damaging conditions, (3) detect (e.g., via accelerometer readings) mishandling incidents such as pallet drops or collisions that may damage shipments, or (4) detect (e.g., via acoustic or accelerometer data) shipment movements, such as in-warehouse movements or transfer to or from transport vehicles.

The illustrative embodiments described herein employ trackers to track discrete shipment objects such as pallets, and opportunistically use third-party wireless devices as sources of data and channels of communication. It will be clear, however, that various embodiments may track fluid flows through supply chains that comprise pipelines, tanks, and the like; in such embodiments, durable, miniature mobile trackers small enough to pass through pumps and coarse filters are added to and travel with fluid flows rather than being attached to discrete pallets or the like. It will also be clear that dedicated or specialized wireless communications are employed by various embodiments alternatively or additionally to opportunistic use of fortuitously present wireless devices.

The terms and expressions employed herein are used as terms and expressions of description and not of limitation, and there is no intention, in the use of such terms and expressions, of excluding any equivalents of the features shown and described or portions thereof. In addition, having described certain embodiments, it will be apparent to those of ordinary skill in the art that other embodiments incorporating the concepts disclosed herein may be used without departing from the spirit and scope of this disclosure. Accordingly, the described embodiments are to be considered in all respects as only illustrative and not restrictive. Moreover, the advantages of various embodiments are not limited to the advantages specifically described herein.

It is to be understood that the above description is intended to be illustrative, and not restrictive. Many other embodiments will be apparent to those of skill in the art upon reviewing the above description. The scope should, therefore, be determined with reference to the appended claims, along with the full scope of equivalents to which such claims are entitled.

What is claimed is:

1. A method of supply chain optimization comprising:
commissioning one or more trackers within a supply chain network, each tracker connected to a shipping unit of a shipping pallet, container, or package, and each tracker having a wi-fi communication module, a battery, a microprocessor, memory, and one or more sensors, wherein the one or more sensors include an accelerometer;
communicating with the one or more trackers through a back end server across a network;
detecting, by each tracker, available wi-fi access points (APs) when not sleeping, and if no AP is found in range sleeping for a short period before attempting to detect APs again;
for trackers which are within wireless range of other trackers but not in range of an AP, forming a mesh network with the other trackers to access an AP within range of the mesh network;
after detection of available APs, sending from the detecting tracker to the back end server a service set identifier (SSID), a basic service set identifier (BSSID), and a received signal strength indication (RSSI) for each available AP, along with any collected sensor data;
determining, by the back end server, tracker location for the detecting tracker based on BSSIDs of available APs detected by that tracker;
triangulating, by the back end server, a precise position of the detecting tracker based on RSSI if multiple available APs are in range of the detecting tracker;
maintaining and updating, by the back end server, an echelon map of the supply chain network based on determined locations of trackers;
identifying, by the back end server, points of interest (POIs) based on tracker location, and providing commands from the back end server to the trackers to disable specific sensors at specific POIs to maximize battery life;
identifying, by the back end server, a new point of interest (POI) to include within the echelon map based on a threshold number of trackers accumulating at a same location not previously associated with a POI;
extracting, by the back end server, a name from an SSID of a AP at the same location;
tracking, by the back end server, residence times for trackers at points of interest (POIs);
including, within the echelon graph, echelon nodes representing types of facilities in the supply chain and including edges between echelon nodes representing movements between the types of facilities;
including, within the echelon map, POI nodes each representing a POI and storing a location, a unique identifier, and statistics about history of tracker activity associated with that POI, and including edges between nodes such that an edge connecting a specific POI node and a specific echelon node indicates that the specific POI is part of the specific echelon;
including, within the echelon map, shipment nodes each representing a shipment and storing an identifier of the shipment, an identifier of a tracker commissioned to the shipment, and information on when the shipment originated, and including lane traversal nodes each storing movement of a specific tracker between two POIs, and including edges between nodes such that an edge between a shipment node and a lane traversal node represents a first movement leg of a shipment, and an edge between two lane traversal nodes represents later movement legs of a shipment;
providing, from the back end server to each tracker, a sleep period duration based on a fraction of an average residence time tracked at a POI at a current location of each tracker;
limiting, by the back end server, the sleep period duration for each tracker to be no greater than a shortest expected transport time from the POI at the current location for that tracker to any other POI to which that tracker may be shipped;
detecting, by the back end server, shipment delays in the echelon map after a specific POI and increasing the sleep period duration for trackers currently at the specific POI;
using, by each tracker, sleep periods between AP detection of the provided sleep period duration to maximize battery life;
waking a tracker from sleep within the provided sleep period duration upon detection of acceleration by the accelerometer of the tracker;
analyzing, by the back end server, the echelon map to determine metrics about distribution of goods across the supply chain, average transit times between POIs, and dwell times at individual POIs; and
optimizing, by the back end server, the supply chain by applying the determined metrics to a model of the supply chain, identifying one or more shipping or routing changes which improve performance of the model, altering the supply chain to apply the identified changes, tracking effects of alterations based on echelon map metric data collected after applying the identified changes, and using the tracking metrics as feedback to refine the model.

2. A method of supply chain optimization comprising:
commissioning one or more trackers within a supply chain network, each tracker connected to a shipping unit of a shipping pallet, container, or package, and each tracker having a wi-fi communication module and a battery;
communicating with the one or more trackers through a back end server across a network;
determining, by the back end server, tracker location for each tracker based on a basic service set identifier (BSSID) of a wi-fi access point (AP) detected by that tracker;
maintaining and updating, by the back end server, an echelon map of the supply chain network based on determined locations of trackers;
providing, from the back end server to each tracker, a sleep period duration based on an estimated residence time spent at a current location of each tracker;
using, by each tracker, sleep periods between AP detection of the provided sleep period duration to maximize battery life; and
optimizing, by the back end server, the supply chain network based on the echelon map, shipping unit locations within the supply chain network, and an expected time to destination based on the estimated residence time spent at the current location of each tracker and expected transit times to further locations within the supply chain network.

3. The method of claim 2, further comprising including a microprocessor, memory, and one or more sensors on each tracker.

4. The method of claim 3, wherein the one or more sensors include an accelerometer, and further comprising waking from sleep within the provided sleep period duration upon detection of acceleration by the accelerometer.

5. The method of claim 3, further comprising detecting available APs when not sleeping, and if no AP is found in range sleeping for a short period before attempting to detect APs again.

6. The method of claim 5, further comprising, after detection of available APs, sending to the back end server the BSSID, a service set identifier (SSID), and a received signal strength indication (RSSI) of each available AP, along with any collected sensor data.

7. The method of claim 6, further comprising triangulating, by the back end server, a precise position of a tracker based on RSSI if multiple available APs are in range of the tracker.

8. The method of claim 3, further comprising identifying, by the back end server, points of interest (POIs) based on tracker location, and providing commands from the back end server to the trackers to disable specific sensors at specific POIs to further maximize battery life.

9. The method of claim 3, further comprising tracking, by the back end server, residence times for trackers at points of interest (POIs), and setting the sleep period duration for each tracker based on a fraction of the average residence time tracked at a POI at the location of that tracker.

10. The method of claim 9, further comprising limiting, by the back end server, the sleep period duration for each tracker to be no greater than a shortest expected transport time from the POI at the location for that tracker to any other POI to which that tracker may be shipped.

11. The method of claim 9, further comprising detecting, by the back end server, shipment delays in the echelon map after a specific POI and increasing the sleep period duration for trackers currently at the specific POI.

12. The method of claim 3, further comprising trackers which are within wireless range of other trackers but not in range of an AP, forming a mesh network with the other trackers to access an AP within range of the mesh network.

13. The method of claim 2, further comprising, within the echelon graph, including echelon nodes representing types of facilities in the supply chain and including edges between echelon nodes representing movements between the types of facilities.

14. The method of claim 13, further comprising, within the echelon map, including POI nodes each representing a POI and storing a location, a unique identifier, and statistics about history of tracker activity associated with that POI, and including edges between nodes such that an edge connecting a specific POI node and a specific echelon node indicates that the specific POI is part of the specific echelon.

15. The method of claim 14, further comprising, within the echelon map, including shipment nodes each representing a shipment and storing an identifier of the shipment, an identifier of a tracker commissioned to the shipment, and information on when the shipment originated, and including lane traversal nodes each storing movement of a specific tracker between two POIs, and including edges between nodes such that an edge between a shipment node and a lane traversal node represents a first movement leg of a shipment, and an edge between two lane traversal nodes represents later movement legs of a shipment.

16. The method of claim 15, further comprising analyzing, by the back end server, the echelon map to determine metrics about distribution of goods across the supply chain, average transit times between POIs, and dwell times at individual POIs.

17. The method of claim 16, further comprising applying, by the back end server, the determined metrics to a model of the supply chain, identifying one or more shipping or routing changes which improve performance of the model, altering the supply chain to apply the identified changes, tracking effects of alterations based on echelon map metric data collected after applying the identified changes, and using the tracking metrics as feedback to refine the model.

18. The method of claim 3, further comprising identifying, by the back end server, a new point of interest (POI) to include within the echelon map based on a threshold number of trackers accumulating at a same location not previously associated with a POI.

19. The method of claim 4, further comprising extracting, by the back end server, a name from a service set identifier (SSID) of a AP at the same location, and flagging the new POI for human operator attention.

20. A system for supply chain optimization comprising:
one or more trackers within a supply chain network, each tracker connected to a shipping unit of a shipping pallet, container, or package, and each tracker having a wi-fi communication module and a battery;
a back end server communicating with the trackers across a network;
wherein tracker location for each tracker is determined by the back end server based on a basic service set identifier (BSSID) of a wi-fi access point (AP) detected by that tracker;
wherein the back end server maintains and updates an echelon map of the supply chain network based on determined locations of trackers;
wherein each tracker uses sleep periods between AP detection to maximize battery life, and the back end server provides sleep period durations based on an estimated residence time spent at a current location of each tracker; and
wherein the back end server optimizes the supply chain network based on the echelon map, shipping unit locations within the supply chain network, and expected time to destination based on the estimated residence time spent at the current location of each tracker and expected transit times to further locations within the supply chain network.
